(19) United States
(12) Patent Application Publication
(10) Pub. No.: US 2013/0272255 A1
(43) Pub. Date: Oct. 17, 2013

(54) Handling Measurements and Reporting for Fixed Devices in Mobile Broadband Networks

(71) Applicants: Jing Zhu, Portland, OR (US); Rath Vannithamby, Portland, OR (US); Ali T. Koc, Hillsboro, OR (US); Maruti Gupta, Portland, OR (US)

(72) Inventors: Jing Zhu, Portland, OR (US); Rath Vannithamby, Portland, OR (US); Ali T. Koc, Hillsboro, OR (US); Maruti Gupta, Portland, OR (US)

(21) Appl. No.: 13/994,719

(22) PCT Filed: Oct. 14, 2011
(86) PCT No.: PCT/US11/56407

§ 371 Date: Jun. 15, 2013

Related U.S. Application Data
(60) Provisional application No. 61/471,042, filed on Apr. 1, 2011.

(51) Int. Cl. H04W 24/10

(52) U.S. Cl. CPC H04W 24/10
USPC 370/329

(57) ABSTRACT

Measurement requirements for user equipment may be reduced or eliminated where the user equipment is a fixed device. In such case, the measurement requirement may be less useful. In machine-to-machine communications, bandwidth may be increased and power consumption may be reduced in some embodiments.

### CROSS-REFERENCE TO RELATED APPLICATIONS

This application claims priority to U.S. Provisional Application Ser. No. 61/471,042, filed on Apr. 1, 2011.

### BACKGROUND

This relates to radio communication networks and, particularly, to networks including both fixed and mobile stations.

In radio communication networks, there are typically mobile devices, such as cellular telephones, that move within and from cell-to-cell. In addition, there may be fixed devices in the network.

In the future, machine-to-machine (M2M) communication is expected to take a substantial portion of the available bandwidth. Many of these machine-to-machine communications will be from or to at least one fixed transmitting or receiving device. Thus, the network may be a complex mixture of both fixed and mobile devices.

The long term evolution (LTE) is a mobile network technology standard that is part of the 3rd Generation Partnership Project (3GPP). It builds on the Global System for Mobile Communication/Enhanced Data for GSM Evolution (GSM/EDGE) and Universal Mobile Telecommunications System/High Speed Packet Access (UMTS/HSPA) network technologies. The radio access for LTE is called evolved UMTS Terrestrial Radio Access Network (E-UTRAN). LTE supports Internet Protocol based traffic with end-to-end quality of service. Voice traffic is supported mainly as Voice over Internet Protocol.

One objective of LTE is to reduce the system and user equipment (UE) complexity, allowing more flexible spectrum deployment and to enable coexistence with other 3GPP radio access technologies (RATS).

### BRIEF DESCRIPTION OF THE DRAWINGS

FIG. 1 is a system depiction for one embodiment of a communication network;

FIG. 2 is a protocol layer architecture for the system shown in FIG. 1 in accordance with one embodiment;

FIG. 3 is a flow chart for one embodiment of the present invention;

FIG. 4 is a flow chart for another embodiment of the present invention; and

FIG. 5 is a system depiction for one embodiment.

### DETAILED DESCRIPTION

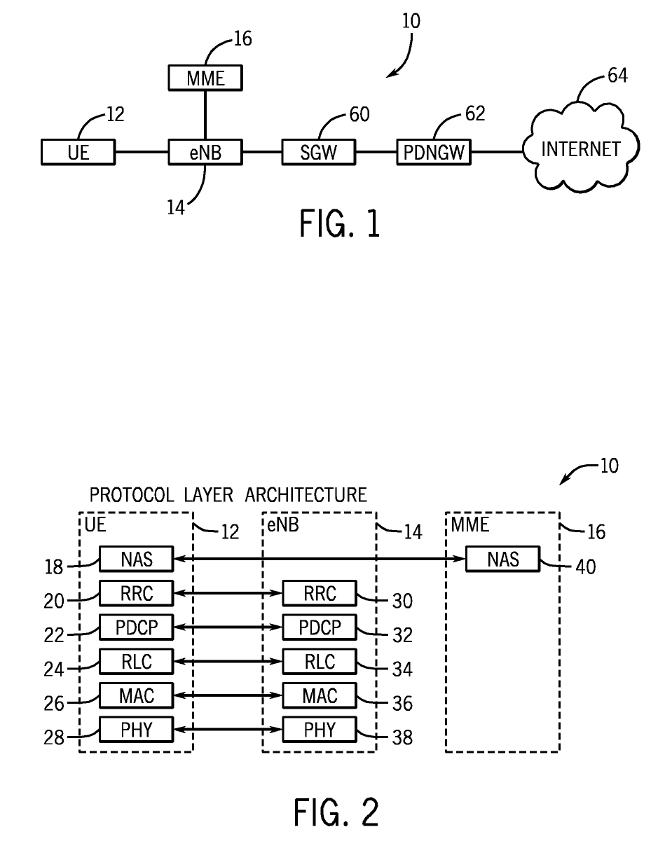

Referring to FIG. 1, a simple network configuration 10 is depicted. It may include a user equipment (UE) 12.

The user equipment may include mobile equipment, such as a cellular telephone, a laptop computer with a radio interface, a handheld computer, such as a personal digital assistant with a radio interface, or an integrated cellular telephone/personal digital assistant, to mention a few examples.

In some embodiments, the user equipment 12 may be fixed or non-mobile. Examples of fixed or non-mobile user equipment may be transmitters and receivers associated with machines that implement a so-called machine-to-machine or M2M communication network.

The user equipment 12 communicates with an eNodeB (eNB) 14 that interfaces with the user equipment. The eNB hosts the physical (PHY), medium access control (MAC), radio link control (RLC), and packet data control protocol (PDCP) layers. These layers may provide user plane header-compression and encryption, in some embodiments. The eNB also provides radio resource control (RRC) functionality corresponding to the control plane. The eNB may provide radio resource management, admission control, scheduling, enforcement of negotiated uplink quality of service, cell information broadcast, ciphering/deciphering, abuser control plane data, and compression/decompression of downlink/uplink user plane packet headers.

The eNB 14 communicates with the mobility management entity (MME) 16. The MME is a control node for the network responsible for idle mode user equipment tracking and paging procedures including retransmissions. It may implement bearer activation/deactivation processes and may also choose the serving gateway (SGW) 60 for the user equipment 12 at the initial attach and at the time of an intra-LTE handover involving core network node relocation. The MME may be responsible for authenticating the user and for checking the authorization of the user equipment to access a service provider's public and mobile network.

The serving gateway (SGW) 60 routes and forwards user data packets. It may also act as a mobility anchor for the user plane during inter-eNB handovers. The SGW may manage and store user equipment contacts, such as the parameters of an Internet Protocol bearer service or network internal routing information.

The SGW 60 is connected to a packet data network gateway (PDN GW) 62 that provides connectivity to the user equipment to external data packet networks. The user equipment may have connectivity with more than one PDN GW for accessing multiple packet data networks. The PDN GW may perform policy enforcement, packet filtering for each user, lawful interception, and packet screening, to mention a few examples. The PDN GW acts as the anchor for mobility between 3GPP and non-3GPP technology, such as Worldwide Interoperability for Microwave Access (WiMAX), as 3GPP. The PDN GW 62 then connects to the Internet 64.

In LTE systems, when the radio resource control connection is established, the serving eNB sends RRC connection reconfiguration messages to the user equipment, informing the user equipment of the set of cells to be monitored and the criteria to be used for measuring and reporting channel strength and quality. However, such measurements may not be needed and can be greatly reduced for a fixed device.

The mobility management entity (MME) 16 includes a non-access stratum (NAS) module 40, shown in FIG. 2, that communicates with an NAS module 18 in the user equipment 12. The NAS layer may be used for the generation and allocation of temporary identities to the user equipment. It may also check the authorization of the user equipment to camp on the service provider's public land mobile network and may enforce user equipment roaming restrictions. In the control plane, the NAS protocol runs between the MME and the UE and is for control purposes, such as network attach, authentication, setting up of barriers, and mobility management. All NAS messages may be ciphered and integrity protected by the MME and the UE.

The radio resource control (RRC) layer 30 in the eNB makes handover decisions based on neighbor cell measurements sent by the UE, pages for the UEs over the air, broadcasts system information, controls user equipment measurement recording, such as periodicity of channel quality information, and reports and allocates cell level temporary identifiers to active user equipment. It may also transfer user equipment context from the source eNB to the target eNB during handover and provides integrity protection of RRC messages. Thus, the RRC layer is responsible for setting up and maintenance of radio bearers. The RRC layer includes the RRC 20 in the user equipment.

The packet data control protocol (PDCP) layer includes a termination 22 in the user equipment and a termination 32 in the eNB. The PDCP layer is part of the user plane responsible for compressing/decompressing the headers of user plane Internet Protocol packets using robust header compression. The layer may also perform ciphering of both user plane and control plane data.

The radio link control (RLC) layer includes a termination 24 in the user equipment and a termination 34 in the eNB. It is used to format and transfer traffic between the user equipment and the eNB. The RLC provides different reliability modes for data transport—acknowledged mode, unacknowledged mode, or transparent mode. The RLC layer may also deliver service data units to the upper layers.

The RCC protocol may include the functions of broadcasting the system information, connection control, inter-RAT mobility, and measurement configuration reporting. The measurement configuration reporting may include the establishment, modification, or release of measurements, including intra-frequency, inter-frequency, and inter-RAT measurements, the set up and release of measurement gaps, measurement reporting, and other functions, including transfer of dedicated NAS information and non-3GPP dedicated information, transfer of user equipment access capability information, support for E-UTRAN sharing. The measurement configuration reporting may also include generic protocol error handling and support of self-configuration and self-optimization.

The MAC layer performs the mapping between logical channels and transport channels, schedules the different user equipments and their services in both the uplink and downlink, depending on their relative priorities, and selects the transport format. The medium access control layer includes the termination 26 in the user equipment and the termination 36 in the eNB.

The physical layer includes the end point 28 in the user equipment and the end point 38 in the eNB 14.

Expansion of LTE in WiMAX to accommodate a large number of fixed M2M devices creates integration problems. Moreover, as the number of M2M connections becomes very large, measuring and reporting communications may unnecessarily consume bandwidth and a processor's cycles. Generally, the measuring and reporting of channel strength and quality is not very important in the case of a fixed device. Thus, in accordance with some embodiments, the fixed device makes it presence known and that it is a fixed device and, based on this information, some measurement and reporting may be eliminated or reduced in some embodiments.

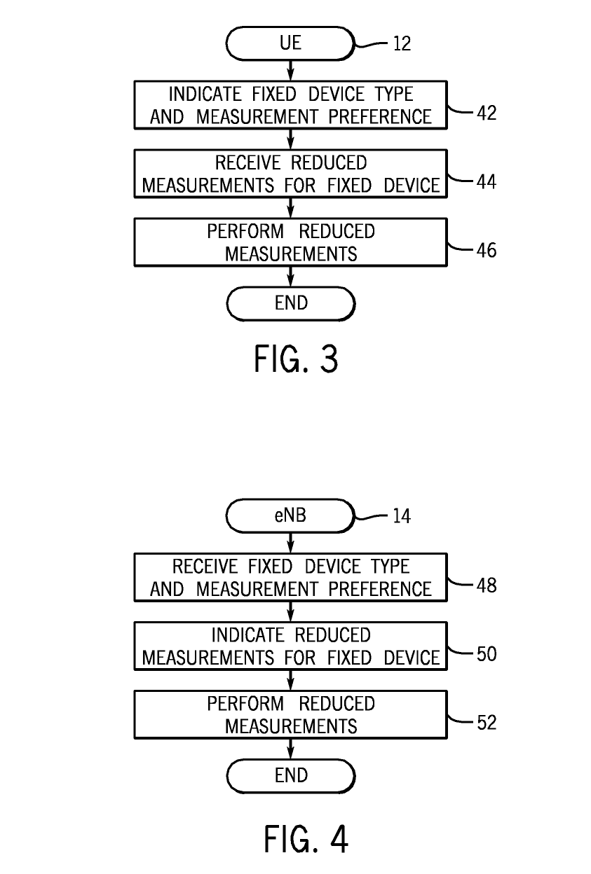

Thus, referring to FIG. 3, a sequence for implementing the user equipment 12 may be implemented in software, firmware, and/or hardware. In software and firmware embodiments, it may be implemented by computer executed instructions stored in a non-transitory computer readable medium, such as an optical, magnetic, or semiconductor storage.

The user equipment 12, shown in FIG. 3, indicates its fixed device type and measurement preference in block 42. Specifically, the user equipment may indicate that it is a fixed device during network entry. It may indicate its supported measurements types, such as inter-frequency/intra-frequency/inter-RAT. For example, the user equipment may decide not to perform any measurements at all, by claiming none of the measurements are supported. Then the user equipment receives the reduced measurements for the fixed device, at block 44, from the eNB 14. When sending out the RRC connection configuration message to a fixed user equipment device, the eNB may minimize the resulting measurement activities by providing less intra-frequency, inter-frequency, or inter-technology channels to measure, less candidates on the listed calls, less information to measure, longer report periods or only the even driven reporting method.

If gap assisted measurement is supported, the eNB may configure the gap pattern with a longer repetition period. For example, in one embodiment, the longer repetition period may be on the order of seconds, so that all the duty cycles can be used for traffic delivery to reduce or minimize the active time of a fixed user equipment device and to save power. Also, the eNB may set the channel quality index feedback period for a fixed user equipment device at a longer time period or may completely disable Physical Uplink Control Channel (PUCCH)-based periodic reporting and only use Physical Uplink Shared Channel (PUSCH)-based aperiodic reporting.

Then the user equipment performs the reduced measurements, as indicated in block 46. There are several measurements that the network/eNB makes, such as the measurement of the angle of the arrival and timing for time synchronization. For a fixed device, these measurements may not be needed. By identifying which devices are fixed devices, the network/eNB can reduce or eliminate these measurements and save network bandwidth and power consumption.

Referring next to FIG. 4, the sequence depicted there may be implemented in the eNB 14. The sequence may be implemented in software, firmware, and/or hardware. In software and firmware embodiments, the sequence may be implemented by computer executed instructions stored in a non-transitory computer readable medium, such as an optical, semiconductor, or magnetic memory.

Initially, the eNB receives the fixed device type and measurement preference from the user equipment, as indicated in block 48. In response, the eNB may indicate reduced measurements for fixed devices, as indicated in block 50. Finally, the reduced measurements may be performed and transmitted to the eNB, as indicated in block 52.

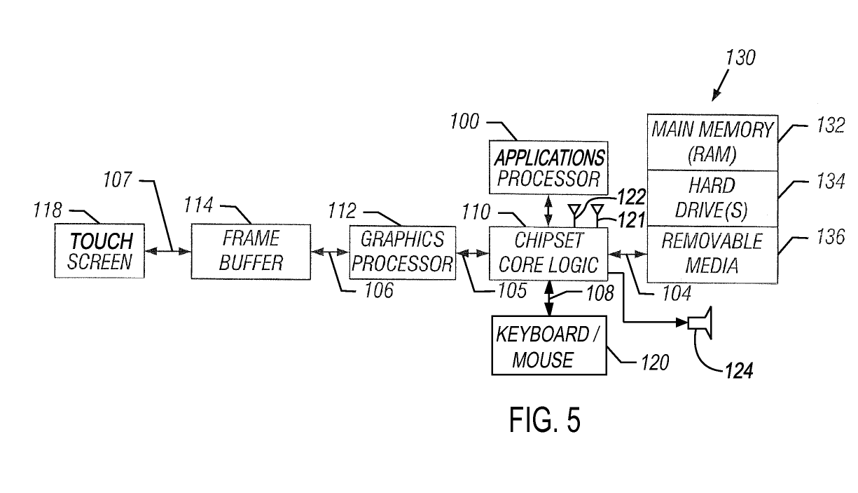

The computer system 130, shown in FIG. 5, may include a hard drive 134 and a removable medium 136, coupled by a bus 104 to a chipset core logic 110. The computer system may be any computer system, including a smart mobile device, such as a smart phone, tablet, or a mobile Internet device. A keyboard and mouse 120, or other conventional components, may be coupled to the chipset core logic via bus 108. The core logic may couple to the graphics processor 112, via a bus 105, and the applications processor 100 in one embodiment. The graphics processor 112 may also be coupled by a bus 106 to a frame buffer 114. The frame buffer 114 may be coupled by a bus 107 to a display screen 118, such as a liquid crystal display (LCD) touch screen. In one embodiment, a graphics processor 112 may be a multi-threaded, multi-core parallel processor using single instruction multiple data (SIMD) architecture.

The chipset logic 110 may include a non-volatile memory port to couple the main memory 132. Also coupled to the logic 110 may be multiple antennas 121, 122 to implement multiple input multiple output (MIMO) in one embodiment. Speakers 124 may also be coupled through logic 110.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
determining whether wireless machine-to-machine user equipment is fixed or mobile;
if the equipment is fixed, assigning reduced wireless measurements to the equipment; and
sending a radio resource control reconfiguration message to the equipment to operate with the reduced measurements.

2. The method of claim 1 including eliminating measurements for the equipment.

3. The method of claim 1 including performing said method in said equipment.

4. The method of claim 1 including performing the method in a unit that communicates with said device.

5. The method of claim 4 including performing the method in an eNodeB.

6. The method of claim 1 including, if the equipment is fixed, reducing the reporting requirements for the equipment compared to mobile user equipment.

7. A non-transitory computer readable medium storing instructions to enable a computer to:
determine whether wireless machine-to-machine user equipment is a fixed, as opposed to a mobile, device; and
if the equipment is fixed, assigning reduced wireless measurements to the equipment using a radio resource control reconfiguration message.

8. The medium of claim 7 further storing instructions to eliminate measurements for the equipment.

9. The medium of claim 8 further storing instructions to perform said method in said equipment.

10. The medium of claim 7 further storing instructions to perform the method in a unit that communicates with said equipment.

11. The medium of claim 10 further storing instructions to perform the method in an eNodeB.

12. A machine-to-machine wireless equipment comprising:
a unit to determine whether an equipment is fixed or mobile and, if the equipment is fixed, assign reduced wireless measurements to the equipment using a radio resource control reconfiguration message; and
an antenna coupled to said equipment.

13. The equipment of claim 12, said unit to eliminate measurements for the equipment if the equipment is fixed.

14. The equipment of claim 12, said unit to reduce reporting requirements if the equipment is fixed.

15. The equipment of claim 12 including a touch screen display.

16. An apparatus comprising:
a unit to determine whether wireless machine-to-machine user equipment that is communicating with said apparatus is fixed or mobile and, if fixed, assign reduced wireless measurements to the equipment via a radio resource control reconfiguration message; and
an antenna coupled to said unit.

17. The apparatus of claim 16 wherein said apparatus is an eNodeB.

18. The apparatus of claim 16, said unit to reduce reporting requirements if the equipment is fixed.

19. The apparatus of claim 16 wherein said apparatus is a base station.
